(19) United States
(12) Patent Application Publication
(10) Pub. No.: US 2022/0400454 A1
(43) Pub. Date: Dec. 15, 2022

(54) Self-Expanding Mesh Network for Position, Navigation, and Timing Utilizing Hyper Sync Network

(71) Applicant: PhasorLab, Inc., Billerica, MA (US)

(72) Inventors: Joshua C. Park, Billerica, MA (US); Devang Topiwala, Framingham, MA (US)

(21) Appl. No.: 17/806,943

(22) Filed: Jun. 14, 2022

Related U.S. Application Data
(60) Provisional application No. 63/210,349, filed on Jun. 14, 2021.

(51) Int. Cl. H04W 56/00; H04J 3/06

(52) U.S. Cl. CPC H04W 56/001; H04W 56/009; H04W 56/006; H04J 3/0661; H04J 3/0644; H04W 84/06

(57) ABSTRACT

A self-organizing mesh network and protocol, herein identified as the HSN Mesh or Self-Expanding Mesh (SEM), enables dynamic addition and subtraction of mesh nodes by allowing nodes to claim a conflict-free slot for transmission. Slot allocation will not be fixed or predetermined and will be performed in a decentralized manner that suits the existing SEM mesh structure which does not have any strict hierarchy or central coordinator nodes. The dynamic slot allocation strategy will allow the seamless expansion of the mesh. The disclosed self-organizing mesh is: a distributed self organizing mobile mesh network; highly reliable and resilient mesh through redundant connections and built in self-discovery; and a peer to peer network with flat hierarchy, meaning no need for central hub or coordinator node. Distributed slot reusability ensures efficient slot allocation. synchronized mesh allows to deploy time critical applications

### CROSS-REFERENCE TO RELATED APPLICATIONS

The present application claims the benefit of priority under 35 U.S.C. § 119(e) to U.S. Provisional App. No. 63/210,349, filed Jun. 14, 2021 and entitled “Self-Expanding Mesh Network for Position, Navigation, and Timing Utilizing Hyper Sync Network,” which is hereby incorporated by reference in its entirety for all purposes.

In addition, the following references are hereby incorporated by reference in their entirety for all purposes: U.S. Pat. Pub. No. US20180206075A1; U.S. Pat. No. 9,538,537; U.S. Pat. Pub. No. US20180146443A1; U.S. Pat. Pub. No. US20170227623A1; U.S. Pat. No. 9,048,979; Pierre Vandwalle, “System and Method For Synchronizing Clocks In A Wireless Local Area Network,” U.S. Pat. No. 8,831,044 B1, Sep. 9, 2014; James M. Hollabaugh, et al., “Methods and Apparatus For Synchronizing clock Signals In A Wireless System,” U.S. Patent Application US2013/0301635 A1, Nov. 14, 2013; Pierre Vandwalle, “System and Method For Synchronizing Clocks In A Wireless Local Area Network,” U.S. Pat. No. 8,306,014 B1, Nov. 6, 2012; Hui Dai et al., “Synchronizing Clocks In Wireless Personal Area Networks,” U.S. Pat. No. 7,409,022 B2, Aug. 5, 2008; Ian Leslie Sayers, et al., “Synchronizing Clock Signals In Wireless Networks,” U.S. Pat. No. 6,542,754 B1, Apr. 1, 2003; Stephen F. Smith, et al., “Carrier-Frequency Synchronization system For Improved Amplitude Modulation and Television Broadcast Reception,” U.S. Pat. No. 6,563,893 B2, May 13, 2003; Timothy M. Schmidl, et al., “Timing And Frequency Synchronization of OFDM Signals,” U.S. Pat. No. 5,732,113, Mar. 24, 1998; U.S. patent application Ser. No. 17/805,451, entitled “Self-Organizing Hyper Sync Network,” filed Jun. 6, 2022.

### BACKGROUND

It is instructive to describe a drone swarm. Drones, typically small and semi- or fully-autonomous, are often configured to swarm together. By staying in a same location or locality as the other drones in the swarm, the swarm is enabled to share resources, reduce computational overhead for sometimes expensive tasks such as routing and wayfinding, and provide physical redundancy and added force multiplication, particularly in military or tactical engagements. A drone swarm requires that the individual drones in the swarm are synchronized in time, to enable synchronized movement together. The drone swarm also requires the location of each drone to be coordinated in some way, for example for some or all drone locations to be known by a central processor or by some or all the individual drones. In some instances, drones in a drone swarm may not have their own GPS, or may share GPS, or may be operating in a GPS-limited or GPS-interdicted environment. In some instances, a drone swarm may be configured to hold a particular orientation in space and may require location information in order to do so.

In TDMA based multiple access mechanisms, an available channel is divided into time slots, which allows nodes to communicate with each other in a collision free manner. Each node takes ownership of a time frame every period and use this frame which is further sub divided into time slots to initiate communication with its neighbors, this is called TDM (Time Division Multiplexing). The concept of diving the available channel can be applied in a frequency domain and such systems are called FDM systems, Frequency Division Multiplexing. HSN can be deployed in both fashions.

### SUMMARY

A proposed mesh network and protocol, herein identified as the hyper sync net (HSN) Mesh or Self-Expanding Mesh (SEM), enables dynamic addition and subtraction of mesh nodes by allowing nodes to claim a conflict-free slot for transmission. Slot allocation will not be fixed or predetermined and will be performed in a decentralized manner that suits the existing SEM mesh structure which does not have any strict hierarchy or central coordinator nodes. The dynamic slot allocation strategy will allow the seamless expansion of the mesh. The disclosed self-organizing mesh is: a distributed self organizing mobile mesh network; highly reliable and resilient mesh through redundant connections and built in self discovery; and a peer to peer network with flat hierarchy, meaning no need for central hub or co-ordinator node. Distributed slot reusability ensures efficient slot allocation. synchronized mesh allows to deploy time critical applications. Simulation of HSN showing Multiple Transmission per Slot/Frame show that even in scenarios with a large number of nodes, given reasonable assumptions about the distance between nodes and radio propagation, the self-established networks tend to be small, and only a very small number of nodes request density control.

In a first embodiment, a method for joining a mesh network by a mesh network node is disclosed, comprising: listening, at a mesh network node, for communications from other mesh network nodes in the mesh network; receiving, at the mesh network node, at least one transmission from the other mesh network nodes from within a communication range of the mesh network node; creating, at the mesh network node, a neighbor map based on the received at least one transmission; sending, from the mesh network node to a master network node, a request to join the mesh network that may include a claimed frame; receiving, at the mesh network node from the master network node, an acknowledgement message that is transmitted by the master network node to a plurality of mesh network nodes; waiting, at the mesh network node, for a set period for voting by the other mesh network nodes in the mesh network; broadcasting, from the mesh network node to the mesh network, an acceptance message during a transmission window corresponding to the claimed frame; and broadcasting, from the mesh network node to the mesh network, a normal protocol message during a transmission window corresponding to the claimed frame, thereby enabling the mesh network to join the mesh network using a dynamic timeslot-based mesh networking protocol.

The mesh network node and at least a subset of the other mesh network nodes may be mobile and in radio frequency communication with each other. The communication range may be a radio frequency communication range determined based on one of more of signal power level and signal to noise ratio. The method may further comprise synchronizing clocks at the mesh network node and at least a subset of the other mesh network nodes. The method may further comprise using a round trip time to estimate distance for creating the neighbor map. The neighbor map may comprise two-dimensional location or three-dimensional location in physical space. The other mesh network nodes perform transmission retransmission and routing via a mesh network protocol. The neighbor map may comprise locations for mesh network nodes reachable via one hop or two hops. The master network node may be a time synchronization master node.

Each of the wireless nodes may utilize a state machine with a rough sync state and an out of sync state and an out of sync hop state to achieve and maintain synchronization. The plurality of regular nodes may be configured to allow a node of the plurality of mesh network nodes to exit the mesh network. The plurality of mesh network nodes each use communicated location and timestamp information to independently generate a neighbor map at each of the plurality of mesh network nodes. The plurality of mesh network nodes may be incorporated into a plurality of moving craft. The plurality of mesh network nodes comprises a drone swarm. The plurality of mesh network nodes may be capable of holding a positional configuration in three-dimensional space and translating the positional configuration in three-dimensional space.

A hyper sync network protocol may be used to synchronize the master network node and the plurality of mesh network nodes. A node of the plurality of mesh network nodes may receive location data of a distant node using one or more message routing hops via nearby nodes. The method may further comprise round trip time measurement (RTTM) location data transmitted with a timeslot-based wireless protocol. The nodes may comprise self-driving craft or vehicles. The nodes may comprise manned or unmanned airborne vehicles.

### BRIEF DESCRIPTION OF THE DRAWINGS

FIG. 1 is a schematic data flow diagram of a Hyper Sync Mesh Network with a single grandmaster node, in accordance with some embodiments.

FIG. 2 is a schematic data flow diagram of a Hyper Sync Mesh Network with two grandmaster nodes and a gateway node, in accordance with some embodiments.

FIG. 3 is a schematic data flow diagram of a Hyper Sync Mesh Network with three grandmaster nodes, in accordance with some embodiments.

FIG. 4 is a schematic diagram of a wireless frequency locked loop for a Hyper Sync Mesh Network node, in accordance with some embodiments.

FIG. 5 is a visual representation of a wireless mesh network changing over time, in accordance with some embodiments.

FIG. 6 shows a HSN TDMA Based MAC Scheduling scheme, in accordance with some embodiments.

FIG. 7A shows an instance of a HSN Mesh at a steady state, in accordance with some embodiments.

FIG. 7B shows an instance of a HSN Mesh adding a node, in accordance with some embodiments.

FIG. 8A shows one embodiment of a node claiming a frame in a network, in accordance with some embodiments.

FIG. 8B shows another embodiment of a node claiming a frame in a network, in accordance with some embodiments.

FIG. 9A is a schematic diagram of a wireless mesh multiple access scheduling message with 10 Slots and 2 Dedicated Reserved Slots, in accordance with some embodiments.

FIG. 9B is a schematic diagram of another wireless mesh multiple access scheduling message Hybrid schedule with 2 slots dedicated for the Contention Based access, in accordance with some embodiments.

FIG. 10 is a flow diagram of a density control request protocol request, in accordance with some embodiments.

FIG. 11 is a flowchart of a power control procedure, in accordance with some embodiments.

FIG. 12 is a schematic diagram of a mesh network undergoing a man in the middle attack, in accordance with some embodiments.

FIG. 13 is a schematic diagram of a mesh network undergoing a wormhole attack, in accordance with some embodiments.

FIG. 14 is an illustration of mesh access control, in accordance with some embodiments.

FIG. 15 is a flowchart of an access control protocol, in accordance with some embodiments.

### DETAILED DESCRIPTION

Various use cases of a drone swarm or positioning-equipped mesh network are well-served by a synchronized, self-organizing mesh network. In some embodiments, a self-organizing mesh drone network is disclosed. The drone network may be a network of unmanned drones or autonomous drones. The drone network may be a wireless network of drones with or without GPS or another satellite navigation technology. The drone network may be self-organizing, in the sense that each drone is capable of awareness of, and kept up to date with the location of the others, and coordinates with the other drones in the network to hold a configuration in space, for example, a configuration where the drones swarm around a central axis, point, or shape and where the drones maintain a safe distance from each other to avoid self-collisions, where the safe distance may vary based on speed, terrain, mission objective, or other factors. The drone network may be configured to gather together in one or more formations, swarms, fleets, or other 3D configurations in space and may be pre-configured or configured during flight. The drone network may be self-organizing for a variable number of drones, or an expanding number of drones, or a set of drones that allows for new drones to be added, or that allows for existing drones to leave and/or rejoin the network.

A hybrid peer-to-peer and master-slave architecture may be used to enable the drones to share location information once synchronized with each other, in some embodiments, where each drone is in communication with a small set of other drones that it is physically close to, which are called its peers or neighbors in this disclosure. Each drone uses a timeslot-based protocol to share timestamps with each of its peers, which are then used at each individual drone to determine the location of each of its peers, thus enabling each individual drone to build a 3D map of the drones nearest to it, in some embodiments. Within each set of peers, one or more master nodes may be designated to share the time sync signal and in some embodiments the parameters or numerology of the timeslot protocol with the slave nodes. Each node (drone) in the drone network may distribute time information synchronized to the master to each of its peers, in some embodiments, where peers are neighbors of each node. Using the nodes that are most physically nearby to a given node allows locations to be determined more precisely, acquired more quickly, and updated more quickly—all of which are important attributes for a location discovery protocol capable of handling fast and precise drone formation changes.

In some embodiments, each set of peers has a master; in other embodiments, a master node propagates its time information across multiple sets of peers with the propagation hop distance dependent on the level of synchronization desired by the operator. The time information is used for location determination, in some embodiments, by use of a time-of-arrival algorithm as described herein or by use of another algorithm. In some embodiments, a node automatically becomes a master node when no master is assigned after it discovers its group of peers after bootup. Discovery of peers may be done in some embodiments by sending out a request message to discover nearby nodes. In some embodiments, a drone swarm may put together and/or share a 3D map of its peers. In some embodiments, an individual drone may use other means to discover nearby drones, such as radar scanning, to create an initial map or refine an existing map.

A single node may be part of multiple sets of peers and may share location information of drones across networks of peers, so that the location of each individual drone propagates through one or more intermediate nodes in the network in a peer-to-peer fashion until each drone has imperfect information about all drones in the swarm, even those which are not its neighbors, in some embodiments. One benefit of this approach is that each drone has the most up-to-date and timely location information about the drones it is closest to, e.g., its neighbors. This enables each drone to effectively, reliably and safely make its own independent navigation decisions using location data, while still enabling a larger set of drones to travel together in a swarm or other configuration. The set of neighbors and peers may be a short distance away (e.g., inches or meters) or a long distance away (e.g., kilometers), depending on the use case, e.g., the peer network for a drone swarm may require a higher precision and higher frequency of updates than a peer network for a regional air traffic control system.

A single drone may be part of multiple sets of peers and may transmit its location to more than one set of peers, in some embodiments. Reuse of timeslots may use knowledge of position, in some embodiments. For example, a particular timeslot may be used by a particular drone to share its location to more than one set of peers, or, a particular timeslot may be used by a first set of peers governed by a first master to communicate with a first drone and the same timeslot may also be used by a second set of peers governed by the same first master to communicate with a second drone, where the first drone and the second drone are far enough apart that they do not need to communicate with each other within the same set of peers.

HSN uses a scoring system consisting of several metrics. One of the key ones being the RSSI and hop away from the Grandmaster. Every HSN node calculates this ranking score and passes it to the neighbors during RTTMs (as used herein RTTM means round trip time measurement and refers to either the measurement, the data of the measurement, or a type of handshake message according to the protocol described herein). The nodes then each independently build a scoring table with their 1-hop neighbor scores and periodically update it. This scoring table allows it to choose the best timing and frequency master at any given time. The node follows the search procedure for picking the best master from neighbors every few periods. If a neighbor with a better score than the current master is found, then a switching procedure takes place. In some embodiments, mechanisms analogous to those found in IEC 61588/IEEE 1588 2009 February, hereby incorporated by reference, or any other version could be used to select a master node.

This procedure provides resiliency to the network in case of several nodes going down. HSN Nodes may store a routing table for an optimal path and backup paths for packet routing between nodes, in some embodiments, and may also send out the periodic network path discovery messages allowing it to keep the routing information up to date.

A grandmaster node is a node that is used as a master by other master nodes, in some embodiments. The closest nodes to a grandmaster are time synchronized to the grandmaster wirelessly. Nodes that are farther away use the nodes closest to the grandmaster as time and frequency synchronization masters. This can continue for several levels to cover all the nodes in the system. If more than one grandmaster is present, each node automatically uses the node with the best connection to the grandmaster as its master. As nodes and masters enter or leave the system, the mesh network reconfigures to find the best available master. In some embodiments, ranking systems ensure the best timing masters at any given time, with support for grandmaster messages and elections. In some embodiments, self-organization is achieved by maintaining communication with neighboring nodes (aside from master nodes). Neighboring nodes serve as the group of potential master candidates for a given node when it loses its master. Use of sync quality ranking system as part of communication in order to inform the neighboring nodes its available options for master node candidates. Most optimal time synchronization can be achieved by use of ranking system in selecting one's master node during the self-organizing process.

In some embodiments, wireless synchronization is used, such as the wireless synchronization described in one or more of: US20180206075A1; U.S. Pat. No. 9,538,537B1; US20180146443A1; US20170227623A1; U.S. Pat. No. 9,048,979, each of which is hereby incorporated by reference in its entirety for all purposes. Where HSN or “Hyper Sync Network” is mentioned, a network using one of the wireless synchronization methods in these incorporated references is understood to be used. The Hyper Sync Network (HSN) uses the proprietary wireless radio to achieve the sub-nanosecond (<<1 ns) level timing and fraction of the ppb (<<1 ppb) level frequency synchronization amongst the nodes. The HSN mesh is frequency agnostic. HSN Mesh forms with at least one Timing Master, (GM—Grand Master). GM node has the capability of generating pulse per second (PPS) sync signals from GPS and can accept external PPS sources as well.

In addition to providing high-quality synchronization, HSN mesh nodes utilize a frequency hopping mechanism to avoid poor local channel conditions such as congestion or RF interference from other nodes outside of Mesh in the case of ISM Band. This allows the mesh nodes to use slightly different carrier frequency every few measurements and provides diversity in measurements which can yield better results when compared to only single carrier frequency measurements.

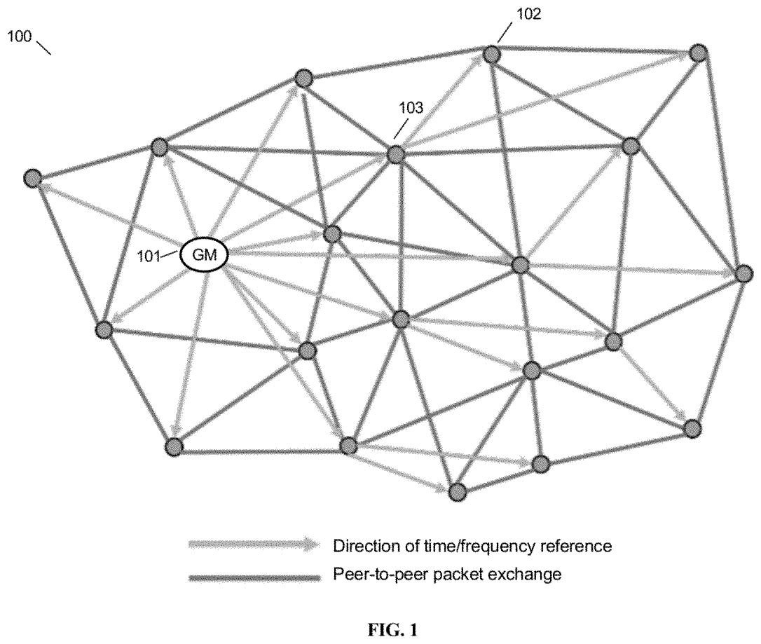

FIG. 1 is a schematic data flow diagram of a Hyper Sync Mesh Network with a single grandmaster node, in accordance with some embodiments. An example of a self-organizing HSN mesh network 100 with a single grandmaster node 101 is shown; at least one grandmaster or master node is needed. Regular node 102 unidirectionally receives time/frequency reference data from grandmaster node 101 via intermediate 1-hop node 103. Data is passed around through the network via intermediate nodes as needed, including peer to peer time data. Regular node 102 receives RTTM messages from its immediate neighbors, including intermediate 1-hop node 103.

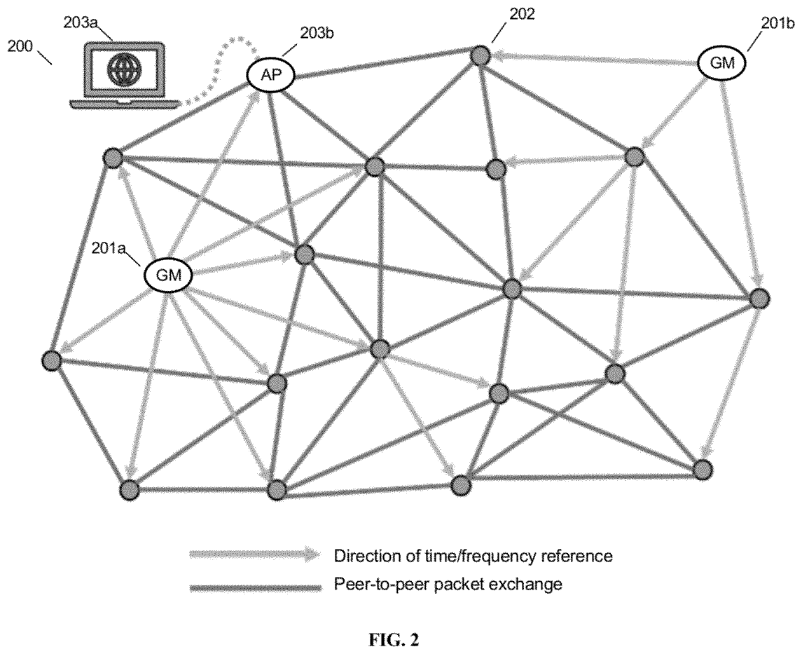

FIG. 2 is a schematic data flow diagram of a Hyper Sync Mesh Network with two grandmaster nodes and a gateway node, in accordance with some embodiments. Two grandmaster nodes 201a and 201b provide time and frequency sync to different subsets of the overall network, such that regular node 202 receives its time and frequency sync from grandmaster 201b; however, 201a and 201b are in tight sync and the entire network remains in sync. Wireless access point 203b participates in the mesh network, and acts as a gateway through laptop 203a to the public Internet. Data is passed around through the network via intermediate nodes as needed, including peer to peer time data. Regular node 102 receives RTTM messages from its immediate neighbors.

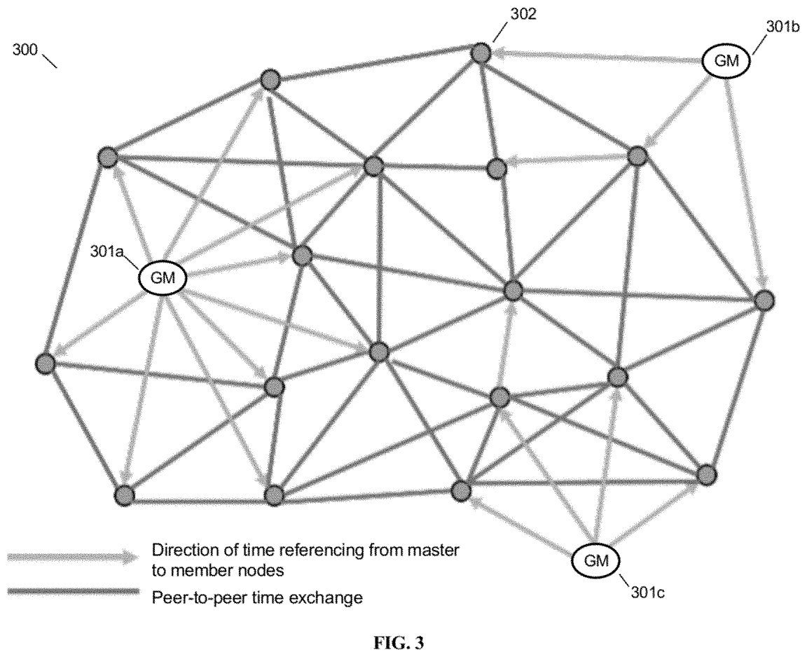

FIG. 3 is a schematic data flow diagram of a Hyper Sync Mesh Network with three grandmaster nodes, in accordance with some embodiments. Three grandmaster nodes 301a, 301b, 301c provide time and frequency sync to different subsets of the overall network, such that regular node 302 receives its time and frequency sync from grandmaster 301b; however, 301a-301c are in tight sync and the entire network remains in sync. Data is passed around through the network via intermediate nodes as needed, including peer to peer time data. Regular node 302 receives RTTM messages from its immediate neighbors.

In some embodiments, the connectivity for a particular mesh network may be enabled to expand without limit aside from the physical bounds of memory and physical space. In some embodiments, the mesh network can allow subnetworks to be associated and disassociated on an as-needed basis, i.e., the mesh network may be self-healing. In some embodiments, multiple mesh networks may be independently coordinated, but a particular node may leave the coordination zone of a first mesh network and subsequently or simultaneously enter the coordination zone of a second mesh network, for example, analogous to the current manually-operated United States air traffic control system. In some embodiments, a node may request, and receive, comprehensive location information for every node in a coordinated mesh network; this comprehensive location information may be delivered to the requesting node over a longer period of time than location updates from its peers. In some embodiments, each node in the mesh network may have a unique identifier allowing it to be identified in a particular mesh network, or across multiple mesh networks or regionally or globally; in some embodiments, the identifier would be administered using a regional, national, or international drone registration regulatory agency. The identifiers could be broadcast by the mesh network nodes to any nearby receivers, in some embodiments.

In some embodiments, the self-organizing mesh drone network may use a timeslot-based communications protocol for coordinating and sharing information among the self-organizing drones. The timeslot-based communications protocol may divide time into periods, frames, slots, and packets, wherein a single packet may be used either for location request or location reply (or requesting or receiving other information). In some embodiments, an algorithm for reuse of communication timeslots is used to enable a drone network to dynamically change a variable number of drones to be organized. In some embodiments, the protocol may use round trip time measurement (RTTM) messages that contain timing information and header fields; the RTTM messages may also carry timing or other data payloads, such as GPS location or control messages, in some embodiments.

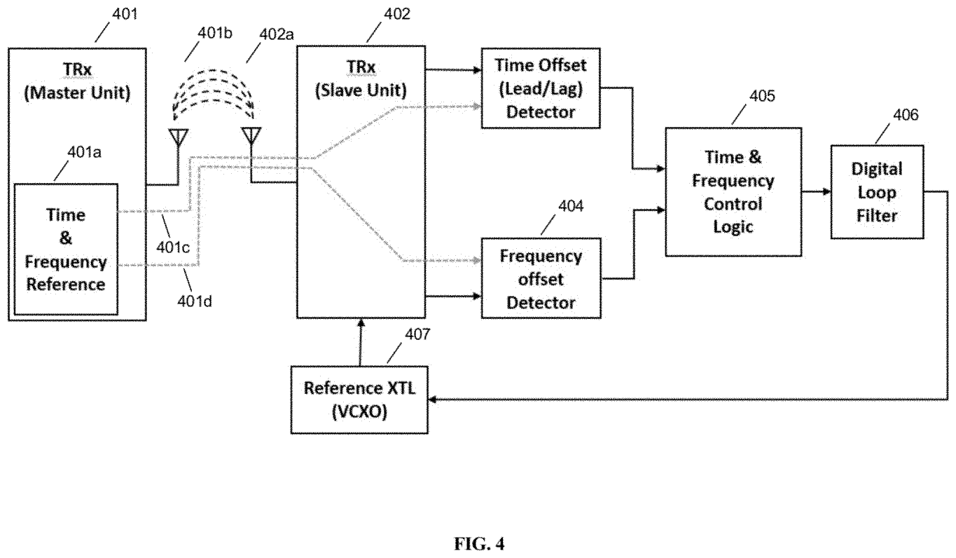

FIG. 4 shows a wirelessly synchronized Time and Frequency Lock Loop System, namely, a schematic block diagram of a master and slave wireless synchronization system, in accordance with some embodiments. In FIG. 4, a master unit transmit/receive unit (TRXU) 401 that includes a time and frequency reference 401a as shown. The frequency reference 401a is shown with a wireless connection via antenna 401b to slave unit transmit/receive unit (TRXU) 402. Time and frequency reference 401a also is connected to the slave unit 402 via the wireless connection, and a time offset signal 401c and a frequency offset signal 401d are shown. In some embodiments, the frequency offset signal received from the master device is called a master device reference signal, and the time offset signal received from the master device is or contains a time stamp, and is called a master device time stamp, in the present disclosure. In some embodiments a specific signal is sent from the master unit 401; however, it is noted that in some embodiments no special signal 401c, 401d are needed, as these offsets can be derived directly from the carrier signal of the master unit, which is received by the slave unit during any data transmission according to any protocol, making the present synchronization system able to operate as a “blind synchronization” system without embedded beacons or prearranged messages, in certain embodiments. Typically, a time stamp is used for time offset signal 401c, and any RF carrier is used for frequency offset signal 401d.

Slave unit transmit/receive unit (TRXU) 402 has an antenna 402a, and sends the time offset signal 401c to the time offset detector 403 and the frequency offset signal 401d to the frequency offset detector 404. In the case that the time and/or frequency offset are derived at the slave and not received as a prearranged synchronization message or time stamp, the received signal may be the carrier signal (e.g., signal samples) and the slave unit TRXU may send it to both the time offset detector 403 and the frequency offset detector 404. The signal samples may be baseband signal samples. Slave TRXU also is part of the signal loop for the reference crystal 407, and passes the reference crystal signal onto the time offset detector and the frequency offset detector.

The time offset detector 403 performs measurement of the signal path delay for the wireless transmission between the master and slave TRXUs. One method for doing so is by time stamp exchange, as described elsewhere herein; in some methods at least one time stamp may be used to bring the master and slave into an initial synchronization state. Another method for doing so is to perform phase offset detection by comparing the timing signal from the reference crystal and the received baseband signal samples from the master TRXU. These methods may be used in conjunction with each other, as the methods have different granularity and applicable ranges, and hence different applications. If a time stamp is used, the time stamp may be extracted from the time stamp message using any means as would be understood by one having skill in the art, such as examining a received bit vector or demodulating a message and decoding the text of the message.

The frequency offset detector 404 performs measurement of the carrier frequency offset between the master and the slave units. As with the time offset detector, multiple methods can be used in conjunction. In a first method, the information from the time offset detection module may be used over time to determine whether the slave unit is gradually slowing down or gradually speeding up, which provides the sign of whether to increase or decrease the clock of the slave unit. In this method, an additional coupling may exist between the time offset detector 403 and the frequency offset detector 404, or a memory or data store could be used to store the time stamp messages for use by either or both of time and frequency offset detectors 403 and 404. In a second method, the frame data or preamble content of a particular message can be used to determine the direction and rate of phase rotation, which can be used to estimate frequency offset. In a third method, a non-preamble blind carrier synchronization technique can be used to estimate the frequency offset in the case of having available I and Q samples; for example, the use of squares or absolute values of the in-phase and quadrature samples could be used. In some embodiments, a carrier frequency may be known in advance, either from past communications or via configuration.

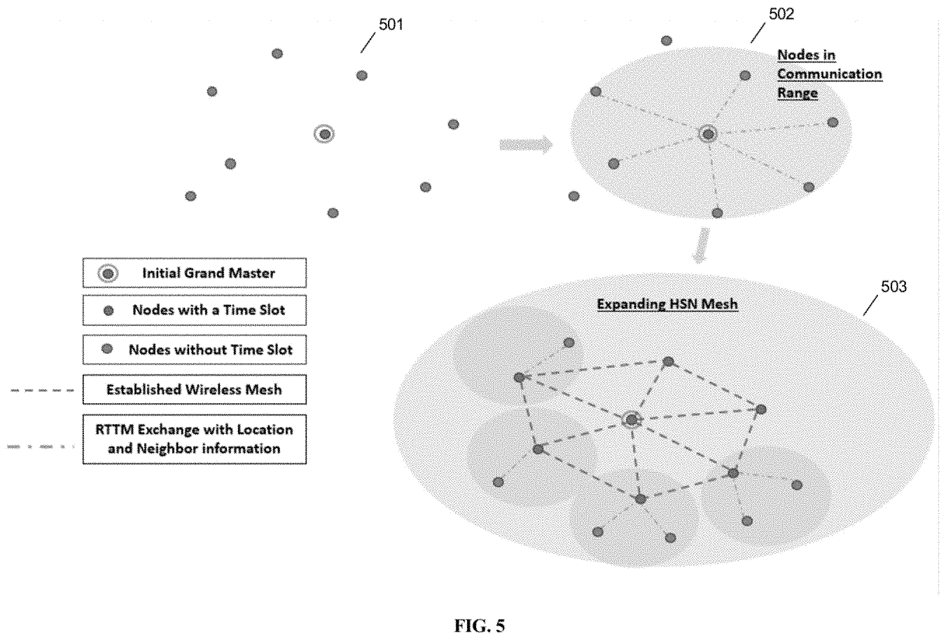

The output of the time offset detector 403 and the output of the frequency offset detector 404 are fed into the time and frequency control logic 405. This logic circuit performs a test to determine whether the reference clock should be sped up or slowed down. The time and frequency logic is described more fully at FIG. 5.

The output of the time and frequency control logic 405 is a digital loop filter 406, such as a low pass filter. The low pass filter performs its typical function as in a PLL, providing filtering of the control signal to reduce jitter and allowing the oscillator to converge to a stable final voltage that is locked onto the input voltage. The digital loop filter may be used to determine the upper limit on the PLL's response.

The output of the digital loop filter is sent as a control signal to the reference crystal 407, completing the closed loop. Reference crystal 407 may have a voltage control for tuning the crystal, enabling the local device to stay in frequency and time lock with the master device. To maintain lock, the system may attempt to keep the time offset and frequency offset within a hold-in range, which is the range within which any perturbations can be damped so as to return the system to a locked state.

Time and carrier frequency of Master node are carefully monitored and its outcome collaboratively decides the way the reference crystal of slave node is being controlled.

In some embodiments, the HSN nodes communicate with each other using Round Trip Time Measurement packets (RTTM). Every HSN node has an addressable networkwide unique Node ID. The RTTM message between the two parties contains the originator's transmission time 501 (T_3−T_OS); upon receiving the packet at 502, the responder time stamps (T2) the package using the described extremely precise time stamping mechanism. At 504 the responder now sends back the packet with both the recorded time stamp called arrival time (T2) and the time of reply (T1). At 503, the initiator in a similar manner time stamps the packet and calls it receive time (T_Rx). Using the RTTM reply the initiator node then corrects its time clock offset (TOS).

T_2−T_d=T_3−T_OS

T_1+T_d=T_Rx−T_OS

So that:

T_OS=((T_Rx+T_3)−(T_1+T_2))/2

T_d=((T_Rx−T_3)−(T_1−T_2))/2

HSN uses multiple mechanisms to correct frequency and time offsets and the method discussed here is one of them. HSN nodes also uses the packet preamble to find the RTTM message arrival time and start of the frame using the described correlation methods. Moreover, HSN nodes also may utilize High-Precision Carrier Synchronization Technology (HPCST) in a blind fashion to measure the frequency and time offsets utilizing the entire packet energy. Successful RTTM measurements allow the nodes to constantly discipline the local time/frequency source.

HSN's tight frequency and timing synchronization allows it to be used as a precision measurement device. HSN provides decimeter level of accuracy across the mesh. The accuracy can be increased by dense deployment and increasing the GDOP.

### Operation of the Mesh

SEM nodes have built-in self-awareness. Every node in the mesh knows its location and that of neighboring nodes, together with their slots and synchronization quality. This will allow us to build a truly self-organizing, self-reliable and resilient network. The network will be able to handle the highly dynamic deployment scenarios with a flexible network topology.

All nodes constantly listen to the wireless network traffic and identify neighbors, their locations, and other information as noted earlier, allowing each node to build an internal map of its local mesh. This approach allows nodes to pick a conflict-free slot to initiate RTTMs. Moreover, nodes can quickly reach a rough time-synchronized state and establish a rough estimate of their position by virtue of multiple one-way measurements in listen-only mode given that enough neighboring nodes are found without transmitting a single packet prior to fully joining the SEM network.

SEM operations can be categorized in two major phases: 1. Boot up Operation; and 2. Steady state Operation.

### Boot Up Operations

FIG. 5 is a visual representation of a wireless mesh network changing over time, in accordance with some embodiments. FIG. 5 illustrates the bootstrapping process of the SEM mesh. At 501, the mesh starts out with the single anchor node indicated with a green dot and with the nodes without slots indicated as blue dots. Next, at 502, the anchor node transmits its location and information about its active neighbors. This allows the blue nodes to build up the map of the localized mesh and to pick their own tentative slots, and subsequently, at 503, through RTTM exchanges derive their locations as indicated in the lower right part of the illustration, which is an expanding and self-organized mesh network.

### Initial Time and Location Estimation

First, each node hears the neighbors' transmission, in some embodiments. The packet transmission in mesh starts from the Anchor nodes. Next, RTTM message contains the positioning information of the nodes and neighbors along with time, the message is transmitted. Nodes time stamp the time of packet arrival using the high precision interpolator. For positioning, a Single one-way measurement gives a solution that lies in a circle with a radius of time delay measurement. Combining multiple of this measurement will subsequently reduce the positioning ambiguity.

Next, in some embodiments, for time synchronization, the measurement consists of t0, time of transmission, and td=time delay between the receiving node and transmitting node. For synchronized mesh, the t0 is starting of a frame/slot boundary. Combining multiple measurement nodes can reach a rough sync state by deriving the slot/frame time boundaries of the mesh.

FIG. 6 shows a HSN TDMA Based MAC Scheduling scheme, in accordance with some embodiments. HSN in current forms uses the TDMA as its medium access scheme. The system is flexible and can be adapted for contention-based and other MAC protocols. One such instance of the TDMA based schedule is shown in the figure. TDMA (time division multiple access) allows precise control over the MAC transmission times and enables HSN to support the deterministic time applications. Every node keeps a local timer and keeps updating it via the exchange of packets with neighboring nodes.

In this instance of the TDMA based schedule, every node is assigned a frame. This frame is subdivided into slots. The owner node of the frame initiates the RTTM message. Typically, during the frame owning node will perform several RTTM with Master node. This allows the node to be in synchronization. Rest of the slot in the frames will be used for keeping track of neighbors via RTTM and passing other status messages allowing the inherent redundancies.

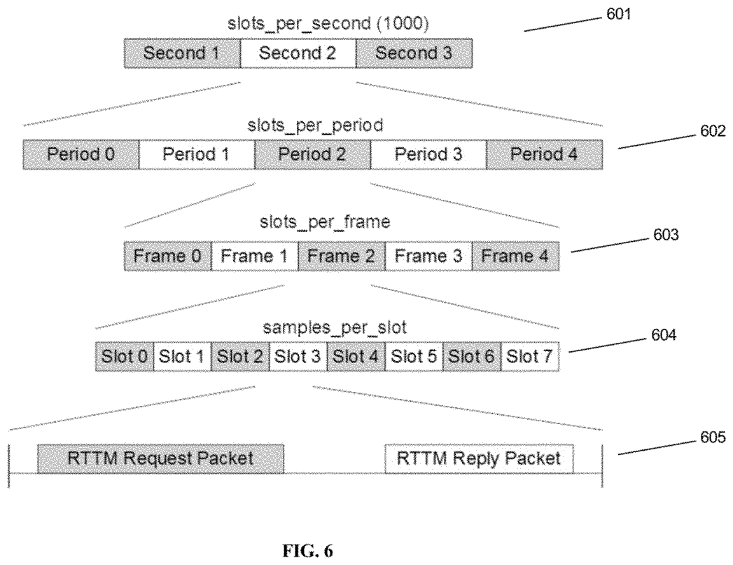

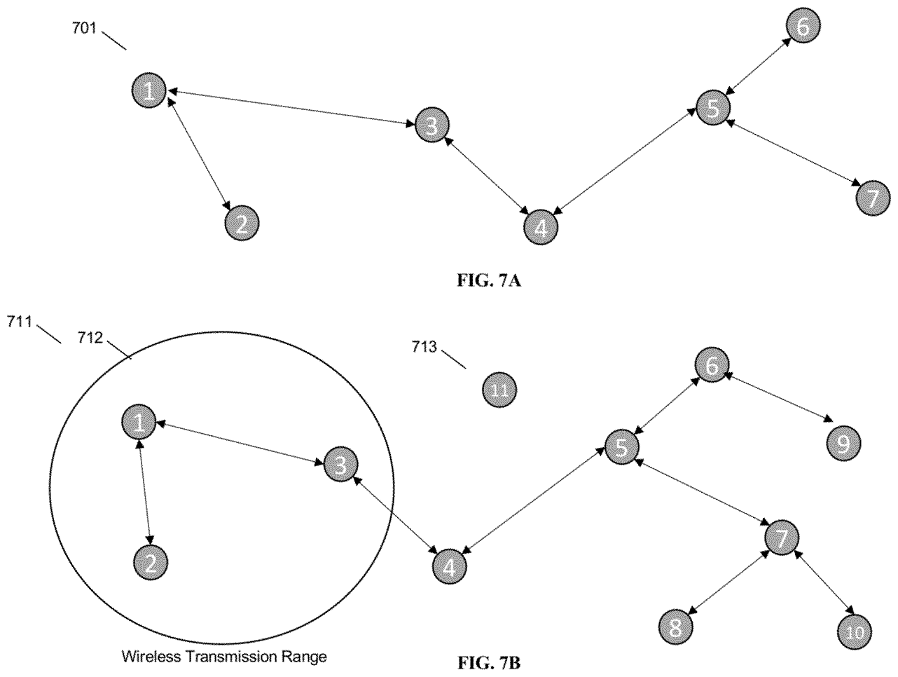

FIG. 7A shows an instance of a HSN Mesh at a steady state, in accordance with some embodiments. Mesh 701 is shown with bi-directional wireless links between the nodes. Not all nodes are connected to each other, but the mesh is routable by the use of routing and retransmission from intermediary nodes, such as node 3.

FIG. 7B shows an instance of a HSN Mesh adding a node, in accordance with some embodiments. Consider the Mesh 701/711 shown in FIG. 7B. The arrows show the established Wireless link. For this mesh, the HSN node number and occupied frame is the same and every node is using the isotropic antenna. Let us assume there are 10 frames per period. Node 11 in the mesh is unable to communicate right now due to now having any slot to occupy. Now we one can see from the figure the wireless transmission range 712 of the node 1 is limited and the signal can only propagate to the area shown in the circle. During node 1's frame ownership it is going to communicate with its neighbors 2 and 3 in our example. During the same time the other nodes in the mesh are idling as they cannot hear the node 1. Hence there is an opportunity to reuse the capacity of the mesh. The node 11 713 can be assigned a frame used by node 1, which is frame no. 1, without adversely affecting the mesh i.e., no collisions. HSN uses the flat hierarchy and hence does not have a central coordinator for the mesh frames/slots like cellular systems in which base stations assign every UE/Mobile node when to communicate. This is either achieved by the means of broadcasting the schedule or communicating along with UE/mobile in one-to-one communication. This method will require this centralized base station to be able to cover the entire range of the mesh. Self-expanding mesh communicates through intermediary nodes in the mesh and can be deployed sparsely to cover the large area.

We solve this problem by letting nodes pick their own slot based on the neighboring nodes information. Our Self expanding mesh achieves this objective by using the precise location of the other mesh members along with the frames/slot they are occupying to avoid the collision and allow nodes to expand in the distributed manner without the need of any Base station like centralized entity to pick a conflict free slot. HSN mesh is able to perform the slot picking in a distributed manner due to extremely tight synchronization amongst the nodes. Without the tight synchronization the TDMA based systems performance will suffers due random offsets in local time and frequency of the nodes.

The nodes in the figure can be placed on the drone and the system still works in the same manner. For example, consider a scenario of the drone fleet flying. Assigning each drone only one frame in the mesh will degrade the positioning performance needed for precise navigation as every node will only be able to communicate once every period with its neighboring node. Our self-expanding mesh will take care of this by reusing the systemwide available frames and using the power control mechanism.

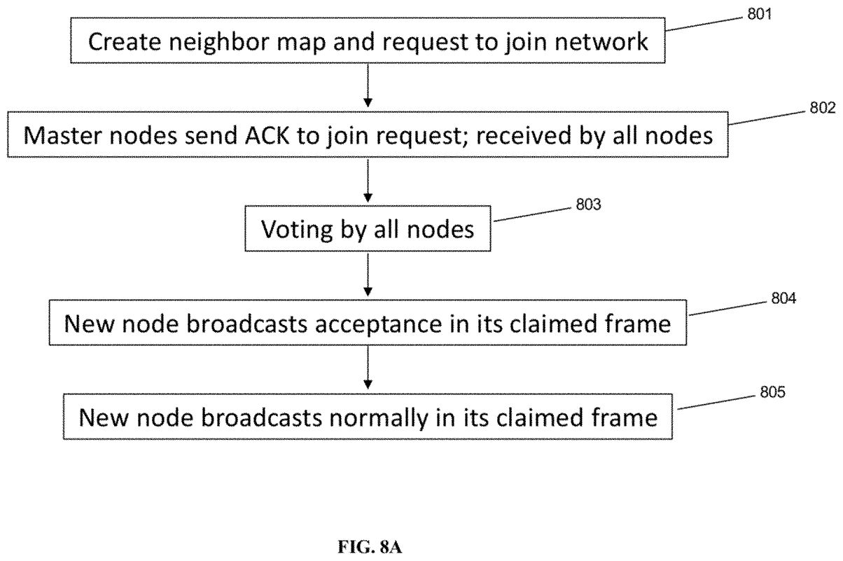

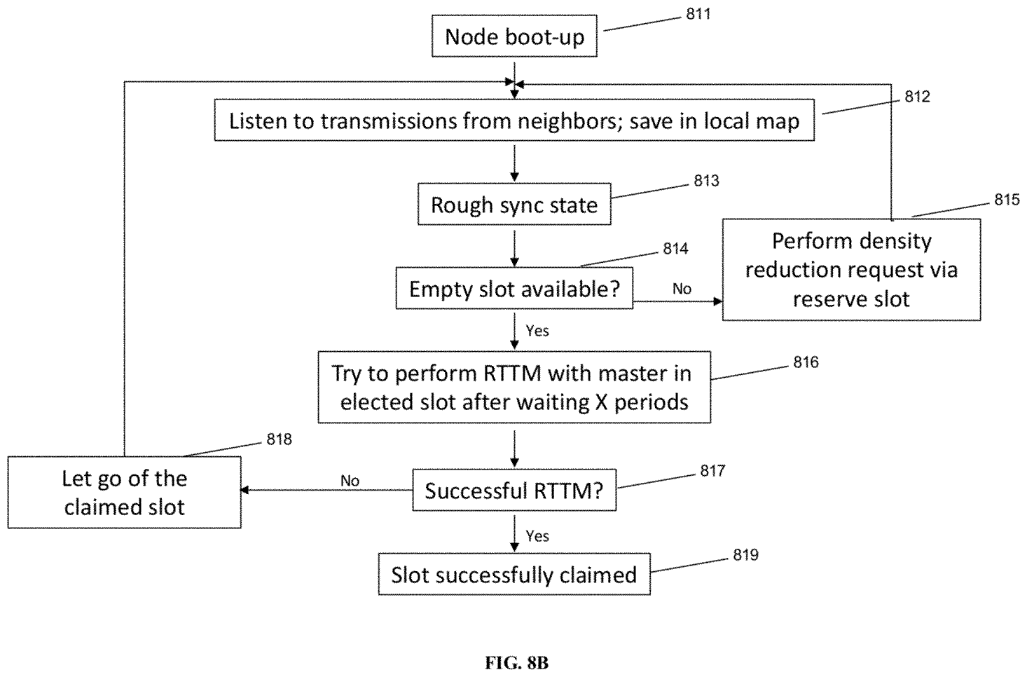

FIG. 8A shows one embodiment of a node claiming a frame in a network, in accordance with some embodiments. In this embodiment, a Self-Expanding Mesh (SEM) algorithm utilizes a voting-based system that allow nodes to join and/or expand the network, as well as leave/contract. The algorithm takes five phases to complete.

In a first phase, a potential candidate initiates the process by requesting to join the network in the reserve frame. The potential candidate is a rough synced node that has listened to the network long enough to build its own Extended Neighbor Map (ENM). An ENM is a list at each node that keeps track of its first and second hop neighbors, along with their respective frames in the sync and communication protocol referred to elsewhere herein. Once the potential candidate has built its ENM, it knows who its optimal master would be and what frames it can take without breaking the network by interfering with existing nodes. With this information, it reaches out to its optimal master node during the reserve frame and shares its ENM with the optimal master node. The reserve frame is a multi-slot frame at the end of each phase reserved for nodes wanting to join the network. This completes the first phase in the process.

During the second phase of the process, the potential master nodes send out an acknowledgment during their assigned frame, which is received by the potential nodes, as well as other nodes in the network. This serves two purposes: it allows any potential candidates to see a conflict arising if there are multiple of them joining, giving them a chance to back off and try again at some other phase; and it provides more information to the surrounding nodes for the voting process.

The third phase is the voting phase, when any node that detects a conflict, whether it is based on the candidate's request, the master's acknowledgment, or both, can vote to deny the request of the joining node. This is to ensure every node that joins a network will not break the network. All nodes must agree on the potential candidates joining for them to be accepted

The fourth phase is where the potential node will validate its acceptance into the network based on the votes and claim the frame by sending out a broadcast in its accepted slot. If any of the nodes voted no, then it will backoff and try joining again at a later phase.

The fifth phase is the first time the new node will broadcast normally in its claimed frame, and all neighbor nodes update their ENM's when they receive this broadcast.

FIG. 8B shows another embodiment of a node claiming a frame in a network, in accordance with some embodiments. First, a node boots up at step 811. Next, at 812, the node listens to transmissions from its neighbors and saves it in a local map. The map stores the locations of its neighbors. This is based on receipt of radio signals using the HSN method, and does not require decoding of the transmissions, in some embodiments. In order to find locations, the node may first attempt a low precision sync, high precision sync, or both. At step 813, the node is in a rough sync state which is enough to decode the transmissions and determine the alignment of frames in the protocol. At step 814, the node looks to see if an empty slot is available. If no slot is available, the reserve slot is available by design; at step 815 the node requests a density reduction request by sending it during the reserve slot. Otherwise, if an empty slot is available, at step 816, the node attempts RTTM with master in the elected slot after waiting a set time (a configurable number of periods of the protocol). Successful RTTM at step 817 results in the slot being successfully claimed 819; otherwise the node lets go of the claimed slot 818 and tries again to obtain sync and to claim a slot.

### Steady State Operations

Once nodes are inducted into the mesh, by claiming at least one slot and communicating successfully with at least one neighbor, we need to address the scenario in which a highly mobile node wanders into a different part of a mesh. The slot claimed by this mobile node may now be owned by another node that is now in range and a collision will occur. We propose the following solutions to this problem:

### Grandmaster Aided Approach (Centralized Solution)

In some embodiments, the Grandmaster/Gateway Node continuously monitors and updates the slots used by the nodes. The GM node sends out periodic corrections to self-chosen slots of nodes. The optimization function considers the metrics such as maximizing the node's distance that have the same slot, allowing more slots and hence more bandwidth to sink nodes i.e. nodes with a high degree of connectivity and avoiding potential slot conflicts in the mobile mesh.

The problem of optimizing the slot allocation can be reduced to a well-studied graph coloring (also known as vertex coloring, k-coloring problem) from the graph theory. In the graph coloring problem [14], the task is to assign each vertex (node) a color such as no two vertices connected by an edge share the same color with a minimum number of colors. The graph coloring problem is considered an NP-complete type problem [14], where NP stands for nondeterministic polynomial time. NP-complete problems can be verified quickly in polynomial time but solving it requires large computations. Techniques to solve NP-complete problems are Approximation, Randomization, Parameterization and Heuristics.

We propose using heuristic-based methods and mixed-integer programming methods to optimally solve the problem with the aid of good metrics of the data, such as the velocity of the moving node and path trajectory prediction to avoid collision by reallocating the potentially conflicting slots. Our custom-built software-defined radio platform allows us to measure parameters such as EVM values, Doppler corrections to frequency parameters, channel noise levels to optimize the transmission power and enhance capacity. Also, in the grandmaster aided approach the nodes have already chosen their initial slots, which it is believed will make the job of optimizing the slots allocation easier than starting from scratch.

In the case of a large mesh, the centralized approach can be tweaked by allocating some of these functions to local Master nodes or sink nodes to avoid latency and bandwidth issues.

### Distributed Approach

We consider the following 3 methods, in some embodiments, for a distributed approach.

### 1. Reserved Slot-Based Scheduling

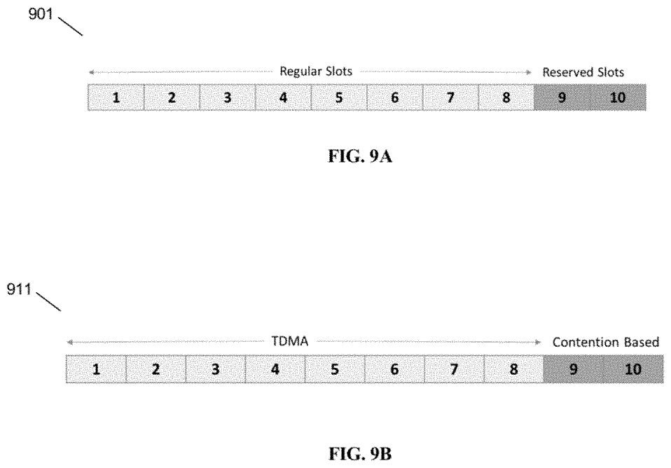

FIG. 9A is a schematic diagram of a wireless mesh multiple access scheduling message with 10 Slots and 2 Dedicated Reserved Slots, in accordance with some embodiments. In this approach, the nodes that are mobile will claim one of the reserved slots while moving. The inbuilt location awareness in the nodes allows them to determine if they are moving or not. In addition to measurements from the mesh, the nodes will be fitted with an IMU, which will also help to determine the node movement. This allows nodes to decide whether they should attempt to use a reserved slot, leaving the regular slots conflict-free. Allowing nodes to pick one of the reserved slots at random minimizes collisions and hence improves throughput.

### 2. Hybrid Channel Access Protocol

FIG. 9B is a schematic diagram of another wireless mesh multiple access scheduling message Hybrid schedule with 2 slots dedicated for the Contention Based access, in accordance with some embodiments. Instead of using a pure TDMA based channel access scheme, we also consider a hybrid approach in which a few slots are accessed using the contention-based schemes such as CSMA schemes and using Request to Send and Clear to Send style small frames (similar to WiFi) to avoid the collision. This allows mobile nodes to access the channel without interfering with other nodes in the TDMA part of the schedule and compete for contention-based slots in a randomized manner to avoid the collision and starving of other mobile nodes.

### 3. Game-Theoretic Score Based Method

SEM nodes keep track of the metrics such as time and frequency synchronization quality, number of hops away from Grand Master (primary timing source), the signal strength of the neighboring nodes and convert it into a score. This score is used to pick an optimal master node. The same score-based method can be used to pick a slot owner in a distributed manner. The node with a higher score will claim the new or existing slot in case it being mobile. This approach does not need a centralized intervention to reallocate the conflicting slots. SEM nodes will exchange the score info in a similar fashion as the location to keep track of the surrounding nodes' scores.

### Density Control Procedure

In SEM mesh the ideally the reuse of slots allows very large capacity. But in case of the deployed nodes>>N, where N is number of slots available systemwide. There might be cases where nodes cannot claim any slot conflict slots due to all the slots being occupied. In this type of deployment, we propose the reserve slot and power control-based mitigation strategy.

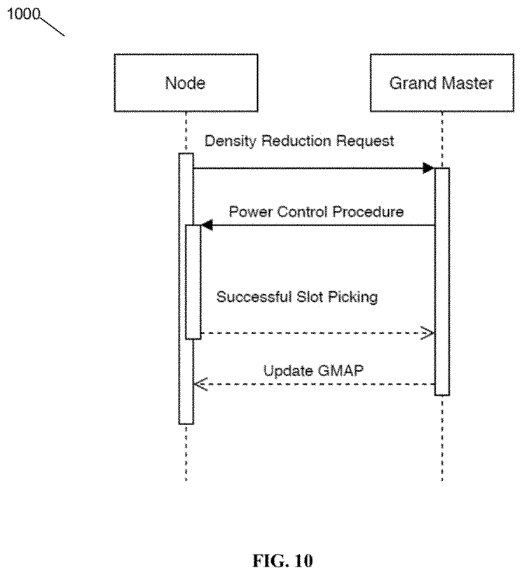

FIG. 10 is a flow diagram of a density control request protocol request, in accordance with some embodiments. The nodes without the slots may make the request to GM for slot allocation via their neighbors using reserve slots. GM should have a regularly updated GMAP [Global Map] of the Mesh. GMAP will have additional information other than location information such as Mesh's Master-Slave relationship, RSSI values of the nodes with their respective neighbors.

### Power Reduction Procedure

In some embodiments, GM may try to reduce the density by controlling the power of the node. This candidate node will be in 2 hop neighborhoods of the node making a request. The general search criteria/policy for finding an ideal node is following:

A. The Candidate Node has an alternate slot to switch to. This is the best option as it does not require performing power control on the candidate node. We can simply switch to the available slot and make the slot available for the original requesting node. The procedure will move forward if no such candidate is found.

B. The node does not have any active slaves and performing power reduction does not make it lose its current Master. If shrinking power causes the change in the master, then there is an equal Rank level neighbor available to be the new master. The RSSI values of the neighboring nodes and Rank level will allow the GM to make an informed decision.

C. If all the candidate nodes have an active slave, then GM will pull all the slaves' nodes info and make sure the power shrinkage does not create the cascading effect of losing a crucial Master for the slaves. This means the candidate node's slave must have an equal or at worst one rank level down neighbor available to the new Master. This also helps ensure that no critical network link is broken as nodes at the critical junctions, Articulation points, are not picked for the power control causing the breakage in the mesh.

D. At last, if no candidate is deemed appropriate from the steps performed so far, then GM will pick the node with one of the best ranks to degrade one Rank level. This will ensure that the mesh wide latency remains the same during the operation. The nodes that are near to master, with better Rank level and low hops, are at worst degrade a level down with this approach.

### Latency Minimization in Mobile Mesh

FIG. 11 is a flowchart of a power control procedure, in accordance with some embodiments. The GM will run an algorithm that will reverse the reduced power of the node. This algorithm will periodically try to assign the full power back to the nodes. In mobile mesh the decision made by the power control algorithm may not stay optimal as the location of the nodes are constantly changing and few mobile nodes may constantly join and leave concentrated areas. By performing the power increment operation, the GM is making sure that nodes are always picking the best available Master and hence have the lowest latency to the GM.

### Security, Anti-Spoofing, & Jamming

By providing end to end encryption in RTTMS to provide the message integrity and Access control to avoid degradation of the positioning or timing synchronization. HSN Nodes are equipped with the high precision interpolator which allows them to eliminate many replay, wormhole, and man in the middle type attacks. The HSN mesh provides secure communication by encrypting the message packets in its entirety. Each RTTM request packet contains the unique node identification and timestamp value. The responding node will decrypt the packet and authenticate the request and response back with its own timestamp. The original requester subsequently determines the clock drift by decrypting the response. The time-sensitive nature of the process along with location awareness allows it to eliminate any adversaries' fake replies or responses including replication, spoofing and the man in the middle type attacks.

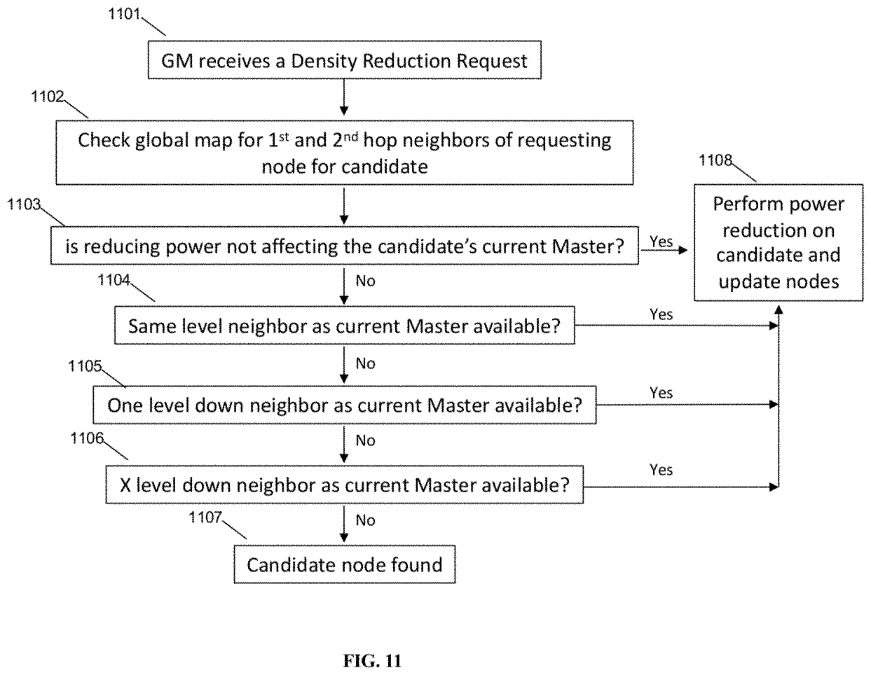

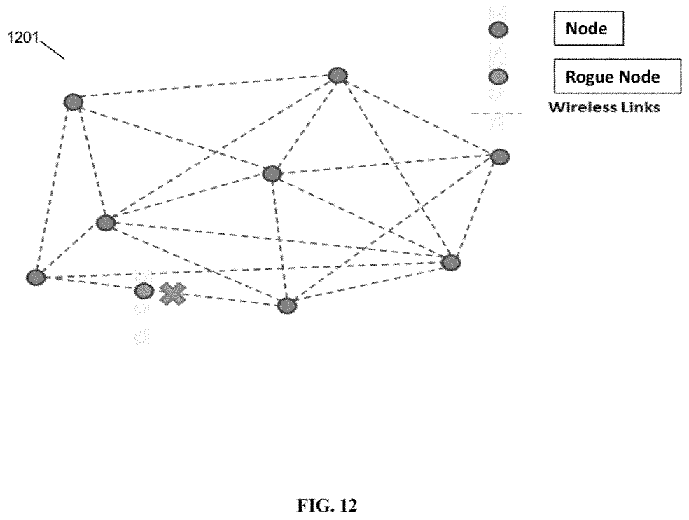

FIG. 12 is a schematic diagram of a mesh network undergoing a man in the middle attack, in accordance with some embodiments. In such a man in the middle attack, the adversary tries to modify the package. In our case due to the wireless nature of the physical medium any captures and replayed messages will be significantly delayed then the original packet and hence the recipient will simply discard it by looking at the Timing fields of the header.

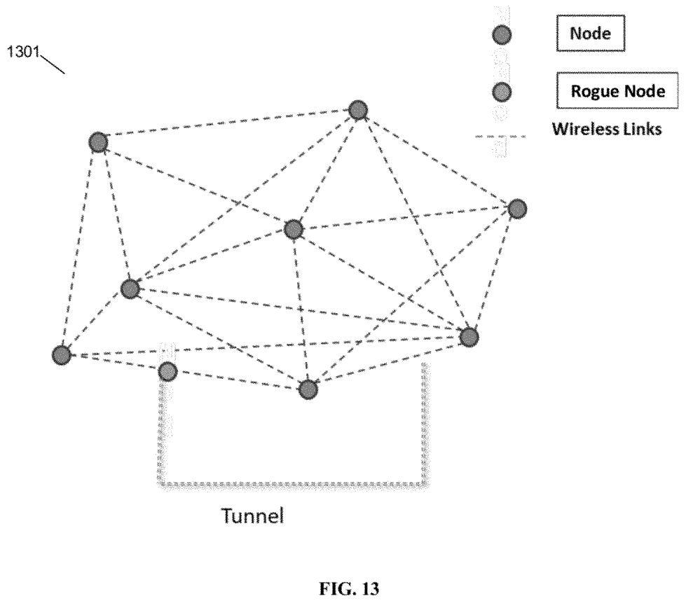

FIG. 13 is a schematic diagram of a mesh network undergoing a wormhole attack, in accordance with some embodiments. Here an adversary captures the packet and replays it into different parts of mesh will also not work due to timing headers in RTTM message also our nodes have prebuilt self-mesh awareness.

In some embodiments, HSN mesh is self-organizing and dynamically routes packages by continuously updating the routing tables and keeping topological information up to date. HSN mesh message passing has an inbuilt redundancy. This protects our mesh from the sinkhole attacks and bringing one of the nodes down does not affect the mesh in its entirety. Our nodes will simply route the package through different paths. Moreover, HSN mesh provides the resiliency against jamming by performing frequency hopping. The frequency hopping sequence can also be randomized amongst several available frequency bands. HSN nodes will perform the multiple measurement fusion and outliers will be dropped by using the clustering and/or other statistical anomaly detection methods.

### Access Control Protocol

FIG. 14 is an illustration of mesh access control, in accordance with some embodiments. On top of providing the timing-based solution to tackle the adversary mesh also may have a built-in Access Control Mechanism. This access control mechanism provides the new node with help to get up and running and simultaneously provides the protection against any degradation to positioning, timing or frequency synchronization. The newly booted nodes can inherit the time and frequency synchronization from already up and running nodes.

FIG. 15 is a flowchart of an access control protocol, in accordance with some embodiments. At 1501, each node in its frame randomly selects 1st hop neighbors to perform RTTM. At 1502, upon receiving the request to perform RTTM from a new node, nodes will store its Unique ID. Nodes will send out this ID to Gateway/Master node of the mesh. At 1504, Master/Gateway node upon receiving will either accept or decline the request. At 1505, nodes already inducted in the mesh will reply to such RTTM request by a new node to aid the synchronization of the new node until the reply comes back from the Gateways or Master node. At 1506, nodes will not send out RTTM request to this new node until the identification is verified by Gateway to Master node.

### Alternative Embodiments

In some embodiments, one or more radios may be used with support for wide range of frequency and different bandwidths. Doppler measurement may be used when available; one-way delay measurements are all that is required to enable the present disclosure. Sub-meter level positioning accuracy is understood to be used for drones and other high-speed and close-distance applications. In some embodiments, a wireless mesh networking stack providing on-demand traffic routing, PPS generation capability for timing and frequency reference, routing new path discovery for nodes within the mesh may be used. In some embodiments, precise timing of the sensor data acquisition may be enabled at each mesh node to enable amalgamating the measurements based on noise profile and accuracy of the node's sensors.

In some embodiments, one or more mesh network nodes may be equipped with GPS etc, and sensor fusion or location understanding may be used to concurrently accommodate other location technologies such as GPS, RTK, Vision based, optical sensor and use it to improve the positioning accuracy by combining measurements. Where transmission of location information or location maps is described herein, location may also incorporate GPS coordinates when and where GPS is available, in some embodiments.

Where GPS is described, other satellite navigation technologies such as GLONASS, Galileo, BeiDou, NavStar, IRNSS, GNSS etc. are considered to be equivalent and understood by the inventors to be able to be used with embodiments of the present invention. Where drones are described, one or more drones may have the ability to allow for manual (remote human or non-human) control or override, and the network described herein may have the ability to self-organize while also incorporating manual control or override, by, for example, allowing the manually-controlled drone to be exempt from a location configuration program or by allowing the manually-controlled drone to be the source of location configuration information for the automatically-controlled drones. As used herein, the words “node” and “drone” as applied to the embodiments disclosed herein are both used to mean a node in a mesh network embodied in a drone or other vehicle, unless otherwise specified. As used herein, location information means 3D location information unless otherwise specified. As used herein, timestamps may be sent or stored with arbitrary precision. Various use cases are also considered to be enabled by the location mesh network of the present disclosure, such as self-driving cars, self-driving taxis, self-flying aerial passenger vehicles, municipal or regional air traffic control, military vehicles, military drones, spacecraft, non-moving mesh network location trackers, etc.

Various additional use cases are also contemplated. In some embodiments, tactical and military use cases are enabled by the disclosed functionality. For example, mesh nodes that are part of the carried equipment of warfighters, or embedded in military vehicles or craft or drones, are considered. The present disclosure is helpful for providing intelligence in the theater regarding the physical location of other nodes, while also scaling up or down and allowing troops or craft to mass together, separate, and/or rejoin, all without any connectivity to an external network.

Another use case that is considered is drone and/or manned craft traffic control. In some embodiments, such as air traffic control, local air traffic control of drones, drone swarms, robotic taxis, flying taxis, manned or semi-autonomous sea, air or land vehicles or craft, etc., there is a need to be able to track the location of vehicles and to be aware of the location of other vehicles, such as to avoid collisions. As well, in many of these situations there is need to have a protocol to deliver messages for more explicit coordination (i.e., landing or takeoff, holding a pattern, three-dimensional or two-dimensional holding patterns, etc). Conventional air traffic control allows for aircraft to enter into a tracking area via a manual handoff between human air traffic controllers. The disclosed functionality allows for air traffic control to be replicated for drones and other small aircraft within a small space in an automated way and with scalability. These characteristics are valuable for drone depots, bases of operations, and landing and takeoff zones, as well as delivery areas. As well, given sufficient radio frequency power to detect and communicate with other craft over a long distance, the present disclosure can also be used for air traffic control. Boundaries are limited by radio strength only, in some embodiments. Different slot numerologies may be used to provide more or fewer slots, in some embodiments, with more slots being available when the present disclosure is operated at a higher frequency.

In some embodiments, when used in drone air traffic control or manned vehicle air traffic control, a mesh network just needs to know if somebody comes up and approaches it, and, in that instance, the network can require the approaching craft to join the network and self organize. So the ones that matter, which is in range, instantly know each other where they are in 3d map. And so as a craft flies around, automatically, it sees the map of all the neighboring mesh nodes, and it can be synchronized in cities, the map is automatically and rapidly formed. And then as the craft flies away, and as another craft flies in, the another craft quickly joins the mesh network. But my craft continues to have my own local map.

In some embodiments 4G or 5G network bands can be used or reused to provide the present functionality. Areas in these network bands that are not being used can be reused for the present protocol. In some embodiments, coordination with military or civilian positioning authorities such as the U.S. FAA (Federal Aviation Administration) is contemplated, including transmission of neighbor maps and locations of individual craft. Landing of a vehicle could result in a mesh network node being taken off of the mesh network. Takeoff of a vehicle could result in the mesh network node being added to the mesh network.

The self-expanding functionality is, in summary, the protocol and architecture that allows for nodes to be added and removed from the mesh network without central coordination, rapidly and at scale. Although nodes being added and removed is a well-understood characteristic of the cellular network, and although ad-hoc networking has been part of the Wi-Fi standard since 802.11b, ad-hoc 802.11b breaks down when a high density of nodes is present. The inventors have contemplated the use of a lightweight timeslot-based contention mechanism to provide this functionality without access points or centralized planning or centralized control, and that additionally has the advantage of creating a physical map of other mesh nodes in the physical space around a given node.

From the foregoing, it will be clear that the present invention has been shown and described with reference to certain embodiments that merely exemplify the broader invention revealed herein. Certainly, those skilled in the art can conceive of alternative embodiments. For instance, those with the major features of the invention in mind could craft embodiments that incorporate one or major features while not incorporating all aspects of the foregoing exemplary embodiments.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A method for joining a mesh network by a mesh network node, comprising:
listening, at a mesh network node, for communications from other mesh network nodes in the mesh network;
receiving, at the mesh network node, at least one transmission from the other mesh network nodes from within a communication range of the mesh network node;
creating, at the mesh network node, a neighbor map based on the received at least one transmission;
sending, from the mesh network node to a master network node, a request to join the mesh network that includes a claimed frame;
receiving, at the mesh network node from the master network node, an acknowledgement message that is transmitted by the master network node to a plurality of mesh network nodes;
waiting, at the mesh network node, for a set period for voting by the other mesh network nodes in the mesh network;
broadcasting, from the mesh network node to the mesh network, an acceptance message during a transmission window corresponding to the claimed frame; and
broadcasting, from the mesh network node to the mesh network, a normal protocol message during a transmission window corresponding to the claimed frame,
thereby enabling the mesh network to join the mesh network using a dynamic timeslot-based mesh networking protocol.

2. The method of claim 1, wherein the mesh network node and at least a subset of the other mesh network nodes are mobile and in radio frequency communication with each other.

3. The method of claim 1, wherein the communication range is a radio frequency communication range determined based on one of more of signal power level and signal to noise ratio.

4. The method of claim 1, further comprising synchronizing clocks at the mesh network node and at least a subset of the other mesh network nodes.

5. The method of claim 1, further comprising using a round trip time to estimate distance for creating the neighbor map.

6. The method of claim 1, wherein the neighbor map comprises two-dimensional location or three-dimensional location in physical space.

7. The method of claim 1, wherein the other mesh network nodes perform transmission retransmission and routing via a mesh network protocol.

8. The method of claim 1, wherein the neighbor map comprises locations for mesh network nodes reachable via one hop or two hops.

9. The method of claim 1, wherein the master network node is a time synchronization master node.

10. The method of claim 1, wherein each of the mesh network nodes utilize a state machine with a rough sync state and an out of sync state and an out of sync hop state to achieve and maintain synchronization.

11. The method of claim 1, wherein the plurality of mesh network nodes is configured to allow a node of the plurality of mesh network nodes to exit the mesh network.

12. The method of claim 1, wherein the plurality of mesh network nodes each use communicated location and timestamp information to independently generate a neighbor map at each of the plurality of mesh network nodes.

13. The method of claim 1, wherein the plurality of mesh network nodes are incorporated into a plurality of moving craft.

14. The method of claim 1, wherein the plurality of mesh network nodes comprises a drone swarm.

15. The method of claim 1, wherein the plurality of mesh network nodes is capable of holding a positional configuration in three-dimensional space and translating the positional configuration in three-dimensional space.

16. The method of claim 1, wherein a hyper sync network protocol is used to synchronize the master network node and the plurality of mesh network nodes.

17. The method of claim 1, wherein a node of the plurality of mesh network nodes receives location data of a distant node using one or more message routing hops via nearby nodes.

18. The method of claim 1, further comprising round trip time measurement (RTTM) location data transmitted with a timeslot-based wireless protocol.

19. The method of claim 1, wherein at least one of the plurality of mesh network nodes comprise self-driving craft or vehicles.

20. The method of claim 1, wherein at least one of the plurality of mesh network nodes comprise manned or unmanned airborne vehicles.
